(19) United States
(12) Patent Application Publication
(10) Pub. No.: US 2012/0139520 A1
(43) Pub. Date: Jun. 7, 2012

(54) Linear Regulator and Electronic Device Comprising Such a Linear Regulator

(75) Inventor: Zhenhua Wang, Embrach (CH)

(73) Assignee: ST-ERICSSON SA, Plan-les-Ouates (CH)

(21) Appl. No.: 13/265,073

(22) PCT Filed: Apr. 21, 2010
(86) PCT No.: PCT/EP2010/055275

§ 371 Date: Jan. 3, 2012

(30) Foreign Application Priority Data
Apr. 23, 2009 (EP) 09305347.8

(51) Int. Cl. G05F 5/08

(52) U.S. Cl. 323/303

(57) ABSTRACT

The invention relates to a linear regulator comprising input means configured to receive an input voltage, output means configured to deliver an output voltage, a shunt element coupled to said input means and said output means, and configured to be passed through by a current and to exhibit across its terminals a voltage drop independent of said current, controllable by-pass means coupled between said input means and said output means, and configured to have a first state for by-passing said shunt element and a second state for not by-passing said shunt element, and control means coupled to said input means and configured to place said by-pass means in their first state or in their second state depending on the value of said input voltage. The invention also relates to an electronic device comprising such a linear regulator.

The present invention relates to a linear regulator, and more particularly to a linear regulator to be used in an electronic device.

Most portable devices, such as cell phones, digital camera or notebooks, utilize at least two kinds of batteries: a main battery used as the main power source, and a coin lithium battery used for real-time clock (RTC) circuit. The battery used for real-time clock will be called “RTC battery” thereafter.

RTC is a clock that must continue to run and keep track of the time even after the system has been turned off. The time period during which real-time clock is running, is called back-up time. In all applications, the duration of back-up time is critically important and has to be as long as possible.

The solution to keep the back-up time longer is to reduce the current that the RTC battery has to deliver. Charging the battery to its highest permitted voltage assures maximum battery capacity for back-up.

As a RTC battery generally provides a voltage up to 3.0 V, whereas available RTC circuit operates only in a supply voltage range of 1.1 V to 2.5 V, a first solution is to charge the RTC battery to a lower and safe level, for example, 2.5 V instead of 3.0 V, to avoid reliability issue. However, the disadvantage is less stored energy in the battery than its capacity, adversely affecting the back-up time.

Another solution to this problem is to bridge the voltage difference between the maximum voltage of RTC battery and the operating voltage of the RTC circuit, by using a voltage converter, such as a linear voltage regulator. This solution is conventional. However, a voltage regulator itself consumes current, and generally more than the RTC does. Therefore the use of a voltage converter limits the back-up time. Moreover, due to the dropout of the voltage regulator, the actually available voltage range reduces, further affecting the back-up time.

Another possibility is a design to use much longer channel MOS transistors capable of withstanding 3.0 V. However, such a design would occupy a very large silicon area and require a new digital library, which has to be created and characterized first, which is not conceivable.

In view of the foregoing, it is hereby proposed according to an embodiment a device increasing the back-up time, in particular with a back-up battery having a maximum voltage higher than the operating voltage of the RTC circuit.

According to an aspect, it is proposed a linear regulator comprising:
input means configured to receive an input voltage,
output means configured to deliver an output voltage,
a shunt element coupled to said input means and said output means, and configured to be passed through by a current and to exhibit across its terminals a voltage drop independent of said current,
controllable by-pass means coupled between said input means and said output means, and configured to have a first state for by-passing said shunt element and a second state for not by-passing said shunt element, and
control means coupled to said input means and configured to place said by-pass means in their first state or in their second state depending on the value of said input voltage.

The linear regulator is based on a voltage drop that is controlled by by-pass means. Such a linear regulator allows the reduction of the quiescent current of the battery back-up system. Moreover, as the battery has a maximum voltage higher than the operating voltage of a RTC circuit, the current that the RTC battery has to deliver is reduced.

The linear regulator does not require the use of an operational amplifier and of a voltage reference. Therefore, the power consumption of such a linear regulator is greatly reduced, compared to a conventional linear regulator, which means a longer back-up time. Moreover, the circuit is simpler and requires a smaller silicon area.

Control means may place by-pass means in the second state if the value of said input voltage is greater than a threshold.

In particular, control means permit to remove the voltage drop to zero (short-circuit) when the voltage of the RTC battery becomes too low. In other words, if the permitted supply voltage of the RTC circuit is between 1.1 V and 2.5 V, then control means will remove the voltage drop if the RTC battery voltage is below or equal to 2.5 V. Moreover, such control means may comprise a MOS switch, instead of a complex error amplifier in conventional linear regulators.

The shunt element may be a passive dipole (e.g. a dipole in which the voltage direction is opposite to the current direction) and more particularly a diode, a zener-diode or a diode-connected transistor.

The operating voltage of theses examples of shunt elements does not depend on the current flowing through them. Indeed, for a diode, for instance, the voltage is either zero or a constant value corresponding to the threshold voltage of the diode. In particular, the small variations of the voltage when the current circulating through the diode increases, are considered as insignificant.

Advantageously, the shunt element is a diode-connected NMOS transistor. In a diode-connected NMOS transistor, the threshold voltage V_{T} is represented by the following equation (1):

V_{T}=V_{T0}+γ·(\sqrt{2·|Φ|+V_{SB}}−\sqrt{2·|Φ|}) (1)

wherein:
V_{T0} represents the zero bias voltage,
γ represents a device constant,
Φ represents a surface potential in a strong inversion layer, and
V_{SB} represents a source-substrate voltage.

The equation (1) represents the effect of back bias. It is possible to use this effect to have a voltage drop that is favourably getting slightly smaller at lower RTC battery voltage. In particular, this modification of the voltage of the shunt element is not due to the current circulating through it, but is due to the voltage between source and substrate.

Indeed, in order to take advantage of back bias, diode-connected NMOS transistor is preferred because the bulk of a NMOS transistor can be grounded, whereas the source and the bulk of a PMOS transistor are tied together, e.g.: V_{SB}=0 V.

Control means may comprise a control input coupled to input means and a control output coupled to by-pass means, a current comparator comprising two inputs and one output coupled to the control output, a constant current generator coupled between the control input and one of the current comparator inputs, and a supply-dependent current generator coupled between the control input and the second of the current comparator inputs. Moreover, the current comparator may also comprise a hysteresis.

The current comparator has inherent hysteresis. Indeed, as the voltage of the control input is decreasing, the current generated by the supply-dependent current generator is also decreasing. Therefore, the hysteresis width of control means increases with time, in particular with switching time of by-pass means, and makes the current comparator tolerant to small disturbances. However, if this inherent hysteresis is considered to be insufficient, or if the working conditions of the linear regulator are not favourable, it is possible to add a hysteresis in control means. In particular, it is possible to use a current comparator with hysteresis different than the inherent hysteresis. In this case, the current comparator with hysteresis may be a Schmitt trigger. The Schmitt trigger allows the increase of the hysteresis width of control means. The hysteresis width corresponds to the sum of the inherent hysteresis width and of the hysteresis width of the current comparator. The hysteresis width is chosen so that to prevent the current comparator from oscillating.

In another aspect, it is proposed an electronic device comprising a battery, a real-time clock circuit and a linear regulator as defined above, wherein the battery is coupled to input means of the linear regulator and the real-time clock circuit is coupled to output means of the linear regulator.

In another aspect, it is proposed a wireless communication apparatus, for example a cellular mobile phone, incorporating electronic device as defined above.

Other advantages and characteristics of the invention will become apparent from the examination of the detailed description, being in no way limiting, and of the appended drawings on which:

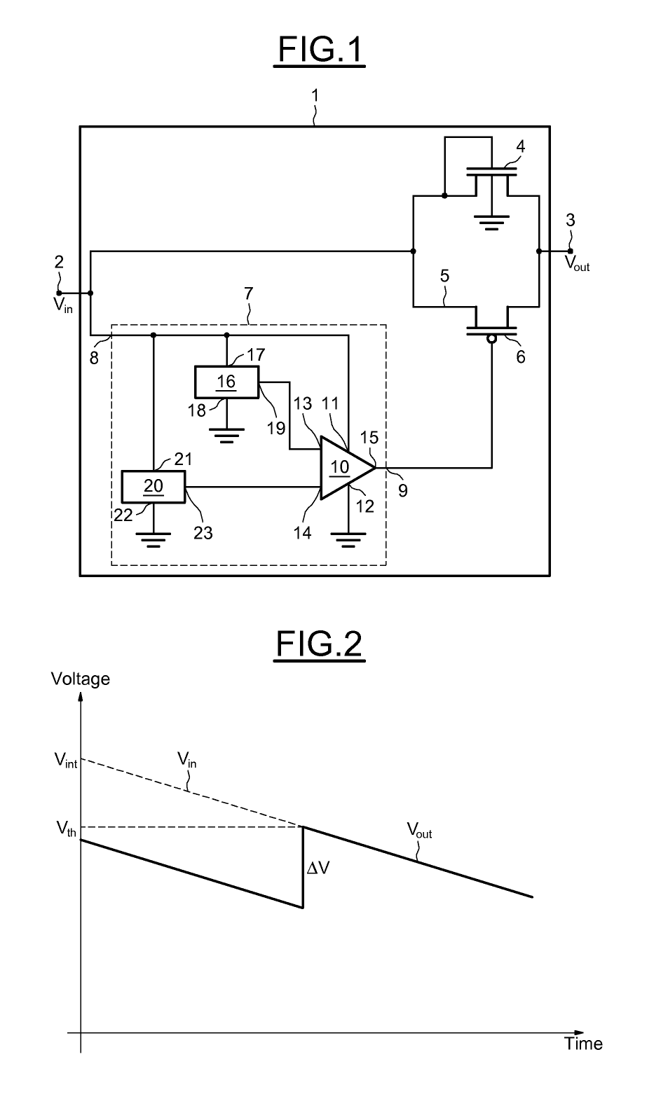

FIG. 1 presents a block diagram of an embodiment of a linear regulator;

FIG. 2 is a graph representing an example of variation of the linear regulator output voltage,

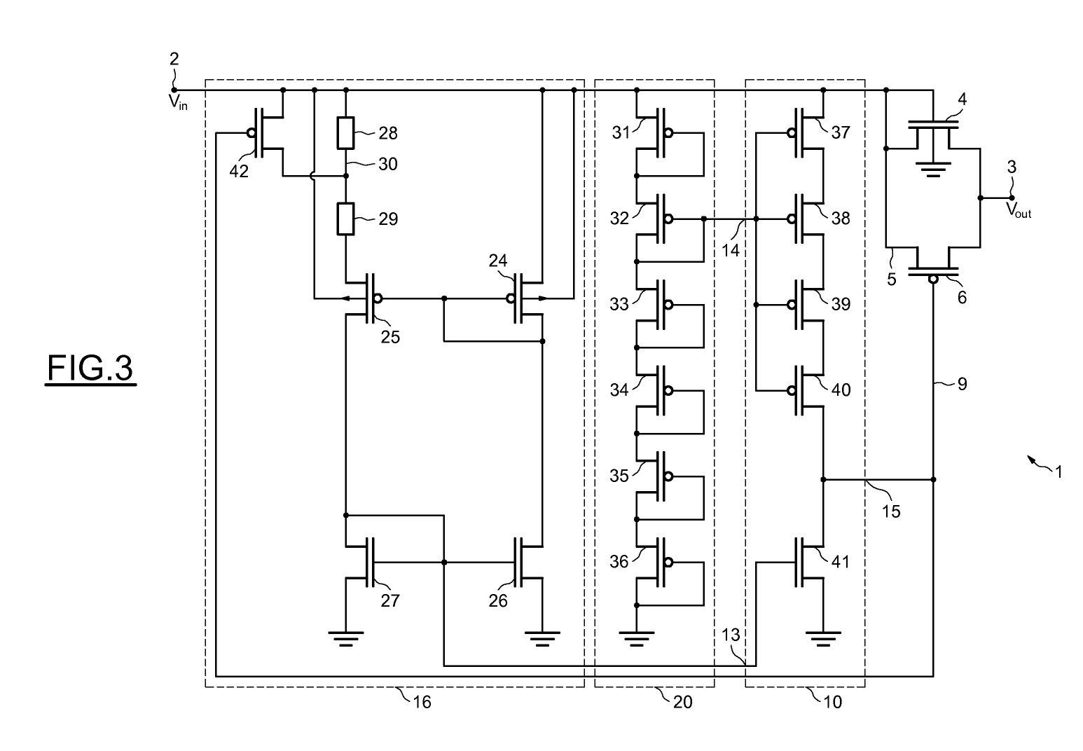

FIG. 3 is a more detailed example of a linear regulator, and

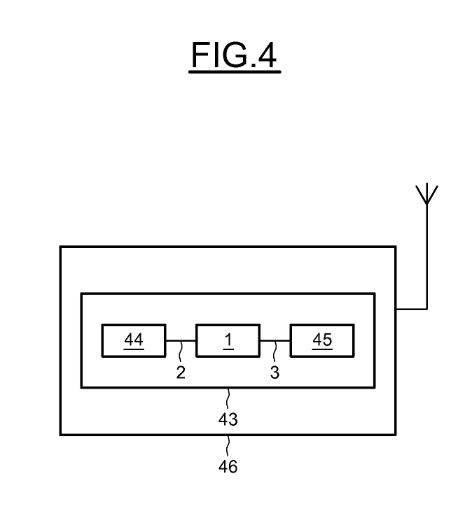

FIG. 4 is an example of application of an electronic device comprising a linear regulator.

As illustrated in FIG. 1, the linear regulator 1 comprises input means 2 and output means 3. Input means 2 are intended to be coupled to a RTC battery generating, for example, a maximum charge voltage of V_{IN}=3.0 V at input means 2. Output means 3 are intended to be coupled to a RTC circuit which presents, for example, a working voltage comprised between 1.1 and 2.5 V. The RTC battery and the linear regulator 1 form a power supply for the RTC circuit, generating an output voltage V_{OUT} at output means 3.

The linear regulator 1 comprises a shunt element 4 mounted in series between input means and output means. The shunt element 4 may be, for example, an NMOS dipole-connected transistor. The shunt element 4 creates a voltage drop between the input voltage and the output voltage. In particular, the voltage drop is independent of the current passing through it.

In parallel to the shunt element are mounted by-pass means 5. By-pass means 5 comprise a switching cell 6, which may be, for example, either a transistor NMOS or a transistor PMOS. In the following description, a PMOS transistor will be used. The switching cell 6 makes the voltage drop switchable, and resets the effective voltage drop to 0V when it is turned on. A switchable voltage drop is thus obtained, instead of a closed-loop regulation.

The linear regulator 1 also comprises control means 7. Control means 7 comprise control input 8 coupled to input means 2, and a control output 9 coupled to by-pass means 5, and in particular to the switching cell 6, in the present case to the gate of the PMOS transistor 6.

Control means 7 comprises a current comparator 10. The current comparator 10 is supplied with power by two supply inputs 11, 12 respectively coupled to the control input 8 and to the ground. The current comparator 10 comprises two inputs 13, 14 and an output 15.

The first input 13 is supplied by the current generated by a constant current generator 16. The constant current generator 16 comprises two power supply inputs 17, 18 respectively coupled to the control input 8 and to the ground, and an output 19 coupled to the first input 13 of the comparator 10. The constant current generator 16 is designed to generate a virtually constant current I_{CC} at the output 19.

The second input 14 is supplied by the current generated by a supply-dependent current generator 20. The supply-dependent current generator 20 comprises two power supply inputs 21, 22 respectively coupled to the control input 8 and to the ground, and an output 23 coupled to the second input 14 of the comparator 10. Unlike the constant current generator 16, the current I_{SDC} generated by the supply-dependent current generator 20 depends on the input voltage of the generator, in the present case depends on the RTC battery voltage. In other words, the current I_{SDC} generated by the supply-dependent current generator 20 either increases or decreases monotonically with the RTC battery voltage. In particular, the current I_{SDC} does not need to vary linearly with this voltage.

The output 15 is coupled to the control output 9, e.g. coupled to the gate of the PMOS transistor 6. The current comparator 10 compares the value of the two currents I_{CC} and I_{SDC} circulating in the inputs 13, 14, and directly controls by-pass means 5 in function of the difference between the two currents.

For instance, when the RTC battery voltage input is above a threshold voltage V_{TH}, the current I_{SDC} entering the second input 14 of the comparator is higher than the current I_{CC} entering the first input 13 of the comparator 10, and the output 15 of the comparator 10 is high so as to turn the PMOS transistor 6 off. The transistor 6 being off, the current drawn by the RTC battery flows through the diode-connected transistor 4, which produces a voltage drop between V_{IN} and V_{OUT}.

When the RTC battery voltage input is below a threshold voltage V_{TH}, the current I_{SDC} entering the second input 14 of the comparator is inferior to the current I_{CC} entering the first input 13 of the comparator 10, and the output 15 of the comparator 10 is low so as to turn the PMOS transistor 6 on. The transistor 6 being on, the current drawn by the RTC battery flows through the by-pass means 5, which by-passes the diode-connected transistor 4 and the power supply output corresponds to the RTC battery voltage.

FIG. 2 is a graph representing the variation of the linear regulator output voltage V_{OUT}. As represented, the RTC battery voltage V_{IN} (dotted line) equals a value V_{INIT} at the beginning, and then decreases with time. As long as V_{IN} is higher than the threshold voltage V_{TH}, a voltage drop ΔV is introduced between V_{IN} and V_{OUT}, so that V_{OUT} is comprised inside the supply voltage range in which the RTC circuit operates.

The skilled person in the art will be able to determine a suitable value of the threshold voltage V_{TH} and a suitable value of the voltage drop ΔV. In particular, the choice of these values will depend on V_{INIT} and on the supply voltage range in which the RTC circuit operates. For instance, the value of the threshold voltage V_{TH} may be chosen in the upper part of the supply voltage range in which the RTC circuit operates. Moreover, the voltage drop ΔV may be chosen so that the value of (V_{INIT}−ΔV) lies inside the supply voltage range in which the RTC circuit operates.

Thus, when the RTC battery voltage V_{IN} equals or is lower than V_{TH}, by-pass means 5 of the linear regulator are turned on so as to remove the voltage drop ΔV: the output voltage V_{OUT} thus equals the input voltage V_{IN} which is inferior to V_{TH}, e.g. is comprised inside the voltage range in which the RTC circuit operates.

FIG. 3 is an example of complete schematic of a linear regulator 1. The linear regulator 1 comprises a diode-connected NMOS transistor 4 coupled in series between input means 2 and output means 3. The linear regulator also comprises a transistor 6 as a switching cell, mounted in parallel to said transistor 4.

The linear regulator comprises a constant current generator 16, a supply-dependent current generator 20 and a comparator 10.

More specifically, the constant current generator 16 includes two PMOS transistors 24, 25, two NMOS transistors 26, 27 and two resistors 28, 29.

The first PMOS transistor 24 is configured as a diode which is coupled between input means 2 and the channel (e.g. the drain region or the source region) of the first NMOS transistor 26. The positive side of the diode is coupled to input means 2. Moreover, the gate of the first PMOS transistor 24 is coupled to the gate of the second PMOS transistor 25.

The first NMOS transistor 26 has a channel coupled between the first PMOS transistor 24 and the ground, and the gate is coupled to the gate of the second NMOS transistor 27.

The second NMOS transistor 27 is configured as a diode which is coupled between the ground and the channel of the second PMOS transistor 25. The positive side of the diode is coupled to the second PMOS transistor 25. Moreover, the gate of the second NMOS transistor 27 is coupled to the gate of the first NMOS transistor 26.

The second PMOS transistor 25 has a channel coupled between the positive side of the second NMOS transistor 27 and the resistor 29. The gate of the second PMOS transistor 25 is coupled to the gate of the first PMOS transistor 24.

The resistors 28, 29 are mounted in series between input means and the channel of the second PMOS transistor 25. More specifically, the resistor 28 is coupled between input means 2 and a node 30, and the resistor 29 is coupled between the node 30 and the channel of the second PMOS transistor 25.

The gates of transistors 26, 27 are coupled to the first input 13 of the comparator 10.

A multi-output current mirror is thus constructed. If the current mirror has unity current ratio, the output current is given by the following equation (2):

$${I}_{CC} = \frac{{U}_{T} \cdot ln ( \frac{{A}_{25}}{{A}_{24}} )}{{R}_{28} + {R}_{29}} \qquad ( 2 )$$

wherein:
R₂₈ and R₂₉ are the resistance of the resistors 28, 29,
A₂₅/A₂₄ is the aspect ratio of the second PMOS transistor 25 to the first PMOS transistor 24, and
U_{T} is defined by:

$${U}_{T} = \frac{K \cdot T}{q}$$

and is about 26 mV at room temperature.

Therefore, the current I_{CC} is not constant but is proportional to absolute temperature. Using such constant current generator 16 instead of a temperature-independent generator has advantage of simplest circuit and ultra-low current consumption.

The supply-dependent current generator 20 comprises for instance six PMOS transistors 31 to 36, mounted in series between input means 2 and the ground. The number of cascade transistors is chosen to minimize power consumption. In this example, six transistors seem to be optimum. The six transistors 31 to 36 are configured as diodes.

Moreover, the gate of the transistor 32 is coupled to the second input 14 of the comparator 10.

The current comparator 10 comprises four PMOS transistors 37 to 40 and one NMOS transistor 41. The four PMOS transistors 37 to 40 are mounted in series between input means 2 and the output connection 15 of the comparator. Moreover, the gates of the four transistors 37 to 40 are tied together and coupled to the second input 14 of the comparator, e.g. to the gate of PMOS transistor 32. Thus, the four transistors 37 to 40 carry current I_{SDC}.

NMOS transistor 41 is coupled between the output connection 15 of the comparator 10 and the ground. Moreover, the gate of NMOS transistor 41 is coupled to the first input 13 of the comparator 10, e.g. is coupled to the gates of NMOS transistors 26 and 27. Thus, transistor 41 carries current I_{CC}.

The number of transistors, their size and the connection to supply-dependent current generator are determined so that I_{SDC} equals I_{CC} when input voltage V_{IN} equals the threshold voltage V_{TH}.

The output of comparator 10 is coupled to the PMOS transistor 6, e.g. controls by-pass means directly. Therefore, short-circuit current is eliminated and the lack of inverter in the linear regulator reduces power consumption.

The current comparator 10 has inherent hysteresis because of supply-dependent input current I_{SDC} and decreasing supply voltage V_{IN}. The hysteresis width increases with the time required by the transistor 6 to switch, and it helps the comparator to tolerant disturbances if they are small.

If this inherent hysteresis is considered to be insufficient, a hysteresis can be introduced to the current comparator, as represented in FIG. 3. A comparator with hysteresis is often called Schmitt trigger. As shown in FIG. 3, the hysteresis comprises a PMOS transistor 42 added in parallel to resistor 28. The gate of transistor 42 is coupled to the control output connection 9.

When V_{IN} is higher than the threshold voltage V_{TH}, the comparator output is high, transistor 42 is cut off and the value of the current I_{CC} is given by equation (2). Upon the comparator switches from high to low, transistor 42 is turned on and bypasses resistor 28. As a result, the value of I_{CC} is given by equation (3):

$${I}_{CC} = \frac{{U}_{T} \cdot ln ( \frac{{A}_{25}}{{A}_{24}} )}{{R}_{28}} \qquad ( 3 )$$

Therefore, I_{CC} increases. The current difference between equation (2) and equation (3) corresponds to a hysteresis width that has been introduced.

However, it is also possible to increase I_{CC} by increasing the A₂₅/A₂₄ ratio. For instance, it may be provided a hysteresis comprising two PMOS transistors. The two transistors, mounted in series, may be mounted in parallel between the resistor 29 and the positive side of transistor 27. The first transistor has his channel coupled to the resistor 29 and his gate coupled to the gates of transistors 24, 25. The second transistor has his channel coupled to the positive side of transistor 27, and his gate coupled to the control output connection 9. When the comparator output is high, the second transistor is cut off, and, upon the comparator switches from high to low, the second transistor is turned on. Thus, the first transistor is included in the loop and I_{CC} increases to:

$${I}_{CC} = \frac{{U}_{T} \cdot ln ( \frac{{A}_{25} + A}{{A}_{24}} )}{{R}_{28} + {R}_{29}} \qquad ( 4 )$$

where A is the aspect ratio of the first transistor.

Similarly, the current difference between equation (4) and equation (2) corresponds to the hysteresis width that has been incorporated.

FIG. 4 is an example of application of an electronic device comprising the linear regulator. The electronic device 43 comprises a linear regulator 1, a battery 44 coupled to input means 2 of the linear regulator 1, and a real-time clock circuit 45 coupled to output means 3 of the linear regulator 1. This electronic device 43 may be used in wireless apparatus 46, such as, for instance, wireless communication apparatus.

Therefore, it has been possible to develop a robust and reliable switchable voltage drop converter, with a low consumption, to provide the required back-up supply for the RTC circuit. In particular, the converter may have a total current consumption of 25 nA at room temperature and at V_{IN}=2.5V. Leakage current is negligible because all transistors have long channel and most of them up to 20 μm. Moreover, the sub-threshold leakages of transistors 4 and 6 are not wasted but they supply the RTC circuit.

1. A linear regulator comprising:
input means configured to receive an input voltage,
output means configured to deliver an output voltage,
a shunt element coupled to said input means and said output means, and configured to be passed through by a current and to exhibit across its terminals a voltage drop independent of said current,
controllable by-pass means coupled between said input means and said output means, and configured to have a first state for by-passing said shunt element and a second state for not by-passing said shunt element, and
control means coupled to said input means and configured to place said by-pass means in their first state or in their second state depending on the value of said input voltage.

2. The linear regulator according to claim 1, wherein control means place by-pass means in the second state if the value of said input voltage is greater than a threshold.

3. The linear regulator according to claim 1, wherein the shunt element is a diode, a zener-diode or a diode-connected transistor.

4. The linear regulator according to claim 3, wherein the shunt element is a diode-connected NMOS transistor.

5. The linear regulator according to claim 1, wherein control means comprise a control input coupled to input means and a control output coupled to by-pass means, a current comparator comprising two inputs and one output coupled to the control output, a constant current generator coupled between the control input and one of the current comparator inputs, and a supply-dependent current generator coupled between the control input and the second of the current comparator inputs.

6. The linear regulator according to claim 5, wherein the current comparator also comprises a hysteresis.

7. An electronic device comprising a battery, a real-time clock circuit and a linear regulator according to claim 1, wherein the battery is coupled to input means of the linear regulator and the real-time clock circuit is coupled to output means of the linear regulator.

8. A wireless communication apparatus comprising an electronic device according to claim 7.
